(19) United States
(12) Patent Application Publication
(10) Pub. No.: US 2008/0056678 A1
(43) Pub. Date: Mar. 6, 2008

(54) Apparatus for reproducing data, method thereof, apparatus for recording the same, method thereof and recording medium

(76) Inventor: Kun Suk KIM, Anyang-si (KR)

Correspondence Address: HARNESS, DICKEY & PIERCE, P.L.C., P.O. BOX 8910, RESTON, VA, 20195, US

(21) Appl. No.: 11/978,644

(22) Filed: Oct. 30, 2007

Related U.S. Application Data
(63) Continuation of application No. 11/506,879, filed on Aug. 21, 2006.

(30) Foreign Application Priority Data
Apr. 18, 2006 (KR) 10-2006-0035036

(51) Int. Cl. H04N 7/00; G06F 3/00; H04N 5/91

(52) U.S. Cl. 386/95; 386/124; 386/125; 725/43

(57) ABSTRACT

In one embodiment, the method includes determining a secondary video stream to reproduce with a primary video stream based on management information stored in a memory. The secondary video stream represents the picture-in-picture presentation path with respect to a primary presentation path represented by a primary video stream. The management information includes identifying information identifying the secondary video stream to reproduce, and the management information includes display information indicating whether to display the secondary video stream. The determined secondary video stream is selectively reproduced based on the management information.

### DOMESTIC PRIORITY INFORMATION

This application claims the benefit of the U.S. Provisional Application Nos. 60/709,807, 60/716,523 and 60/737,412 filed Aug. 22, 2005, Sep. 14, 2005 and Nov. 17, 2005, respectively, which are all hereby incorporated by reference in their entirety.

This application is a continuation of U.S. patent application Ser. No. 11/506,879 filed on Aug. 21, 2006, the entirety of which is hereby incorporated by reference.

### FOREIGN PRIORITY INFORMATION

This application claims the benefit of the Korean Patent Application No. 10-2006-0035036, filed on Apr. 18, 2006, which is hereby incorporated by reference in its entirety.

### BACKGROUND OF THE INVENTION

1. Field of Invention

The present invention relates to a method and an apparatus for reproducing data from and/or recording data in a recording medium or storage and the recording medium.

2. Discussion of Related Art

Recently, optical discs capable of recording large-scale data as record media are widely used. To meet the rising demand for video data of high image quality and audio data of high sound quality, HDTV and MPEG2 have been provided. For instance, if video data amounting to one HDTV movie is stored in a disc with MPEG2 image quality, a high-density recording medium having at least 20 Gbyte data storage capacity is demanded.

To meet this demand, Blu-ray disc, HD-DVD (high-definition digital video versatile disc) and the like have been developed as next generation recording media. And, many efforts have been made to develop an optical record player according to high definition recording medium specifications.

However, despite the increasing possibility in recording and reproducing at least two kinds of video stream data simultaneously due to the development of high definition recording media, a suitable reproducing method has not been proposed so far.

### SUMMARY OF THE INVENTION

The present invention relates to a method of managing reproduction of at least one picture-in-picture presentation path.

In one embodiment, the method includes determining a secondary video stream to reproduce with a primary video stream based on management information stored in a memory. The secondary video stream represents the picture-in-picture presentation path with respect to a primary presentation path represented by a primary video stream. The management information includes identifying information identifying the secondary video stream to reproduce, and the management information includes display information indicating whether to display the secondary video stream. The determined secondary video stream is selectively reproduced based on the management information.

In one embodiment, a state of the display information is set based on an instruction. For example, the instruction may be received from a use, an application program interface, or etc.

One embodiment further includes decoding the secondary video stream even if the display information indicates not to display the secondary video stream.

Another embodiment further includes reading a management table from navigation information recorded on a recording medium. The navigation information includes secondary video stream entries, and the identifying information for a selected one of the secondary video stream entries is stored in the memory.

In a further embodiment, the management table further includes combination information. The combination information indicates the secondary audio streams that are combinable with the secondary video stream. A secondary audio stream number identifying a selected one of the secondary audio streams indicated by the combination information is stored as the identifying information.

Yet another embodiment further includes determining a secondary audio stream to reproduce with the secondary video stream based on the management information stored in the memory. The determined secondary audio stream is reproduced based on the management information.

The present invention also relates to a reproduction apparatus.

In one embodiment, the reproduction apparatus includes a memory unit and a controller. The memory unit is configured to store management information. The management information indicates a secondary video stream to reproduce and indicates whether the secondary video stream is to be displayed. The controller is configured to control reproduction of the secondary video stream based on the management information. The secondary video stream represents the picture-in-picture presentation path with respect to a primary presentation path represented by a primary video stream.

In one embodiment, the memory unit includes at least one status register.

In one embodiment, the management information includes a flag indicating whether to display the secondary video stream. In this embodiment, the controller may set a state of the flag based on a received instruction. For example, the instruction may be received from a user, an application program interface, or etc.

In one embodiment, the apparatus further includes a decoder configured to decode the secondary video stream, and the controller is configured to control the decoder to decode the secondary video stream even if the management data indicates not to display the secondary video stream.

Yet another embodiment includes a driver configured to drive a reproducing device to reproduce data. The controller is configured to control the driver to reproduce a management table. The management table indicates a number of secondary video stream entries, and the controller stores a secondary video stream number identifying a selected one of the number of secondary video stream entries in the memory unit as part of the management information.

In one embodiment of the apparatus, the management information indicates a secondary audio stream to reproduce and indicates whether the secondary audio stream is to be played.

In a further embodiment of the apparatus, the management information includes size information indicating a size to display the secondary video stream, and the controller is configured to control reproduction such that the secondary video stream is displayed at the size indicated by the size information.

For example, the size information stored in the memory may be received from a user, an application program interface, or etc.

In one embodiment, the controller is configured to control a driver to reproduce metadata from a playlist recorded in the recording medium. The playlist indicates at least the primary video stream to reproduce, and the metadata including the size information. The controller is configured to store the size information in the memory unit.

The present invention further relates to a recording medium having a data structure for managing reproduction of at least one picture-in-picture presentation path.

In one embodiment, the recording medium includes a secondary video stream number area and a first flag area. The secondary video stream number area stores a number identifying a secondary video stream to reproduce from another recording medium. The secondary video stream represents the picture-in-picture presentation path with respect to a primary presentation path represented by a primary video stream. The first flag area stores a first flag indicating whether the secondary video stream is to be played.

The present invention also relates to an apparatus and a method for recording the data structure for managing reproduction of at least one picture-in-picture presentation path.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a diagram of one embodiment of reproducing data within a recording medium and/or storage via an optical record player;

FIG. 2 is a diagram of a file structure recorded in an optical disc as a recording medium of the present invention;

FIG. 3 is a diagram of a recording structure of an optical disc as a recording medium of the present invention;

FIG. 4 is a diagram for explaining a reproduction of a secondary video according to an embodiment of the present invention;

FIG. 5 is a schematic block diagram of an overall configuration of an optical record player according to an embodiment of the present invention;

FIG. 6 is a schematic block diagram of a playback system according to one embodiment of the present invention;

FIG. 7 is a diagram of a data reproducing apparatus utilizing a playback system according to an embodiment of the present invention;

FIG. 8A is an exemplary diagram of a status memory unit provided to a reproducing apparatus according to an embodiment of the present invention;

FIG. 8B is an exemplary diagram of PSR14 as a part of the status memory unit shown in FIG. 8A;

FIG. 9 is an exemplary diagram of syntax of a table including information for a secondary video stream according to an embodiment of the present invention; and

FIG. 10 is a flowchart of a method of reproducing data according to an embodiment of the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

For the purposes of example only, an optical disc such as a DVD, Blu-ray disc (BD), HD-DVD, NFR (near field recording) disc, etc., will be used as an example recording medium in describing the present invention, but it will be understood that the present invention is not limited to optical discs as the recording medium. For further convenience of explanation, the present invention more particularly takes a “Blu-ray disc (BD)” as an example of a record medium. Yet, it is apparent that the technical idea of the present invention is identically applicable to other record media including HD-DVD and the like.

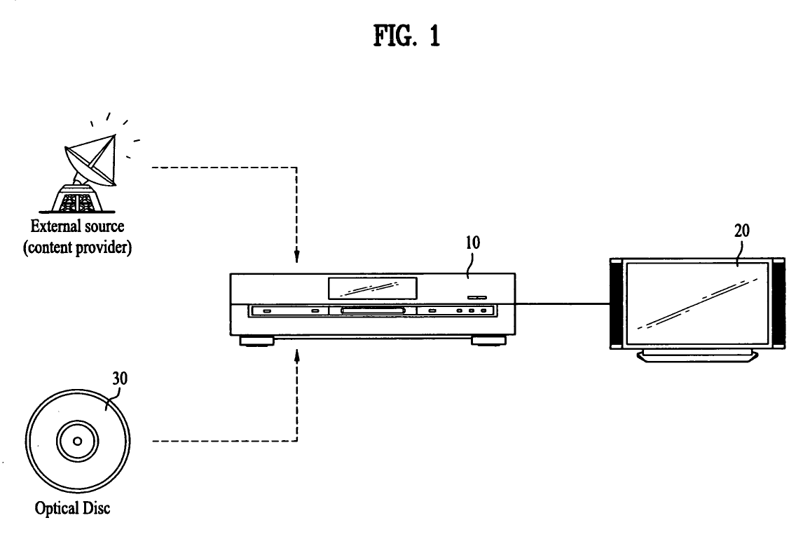

In the present invention, “Storage” may be a storage means provide within an optical record player such as shown in FIG. 1, and means an element which can randomly store information and data. In particular, the storage currently used in general, includes a “hard disc”, “system memory”, “flash memory” or the like, which does not put limitation on the scope of the present invention.

The “Storage” may be utilized as a means for storing data associated with a recording medium. The data associated with the recording medium to be stored within the storage may include data externally downloadable such as from the internet.

It will also be apparent that data directly read out of a recording medium, in part, or a generated system data (e.g., metadata, etc.) associated with reproduction of data recorded in the recording medium may be stored within the storage.

“Contents” in the following description may be data provided by a record medium author as contents configuring a title.

And, a party, who provides content, is generically named a “content provider (CP)”.

For convenience of explanation of the present invention, the data recorded within the recording medium shall be called “original data” and the data obtained outside the recording medium and associated with the recording medium shall be called “additional data”. The original and additional data are classified according to acquisition methods only. So, data existing outside an optical disc and having any kind of attribute associated with original data can be called additional data.

“Title” as used in the following description may be a unit of reproduction configuring an interface with a user. Each title is linked to a specific object. And, a stream associated with the corresponding title recorded within a disc is reproduced according to a command or program within the object. In particular, for explanation convenience of the present invention, a title having a moving picture, movie and interactive information according to MPEG2 compression among titles recorded within a disc shall be named a “HDMV Title”. And, a title having moving picture, movie and interactive information executed by a Java program among titles recorded within a disc shall be named a “BD-J Title”.

“PiP (Picture-in-Picture)” used in the following description means a function of playing a secondary video on an image of a primary video that is being reproduced.

“Reproduction management data” used in the following description means information used in managing a reproduction of a video or audio stream. And, a stream number (STN) table containing video stream entry information and audio stream entry information and metadata managing a secondary video playback are included in the “reproduction management data”.

The above-explained terminologies are replaceable by any terms indicating the same functions, respectively.

FIG. 1 shows one embodiment of reproducing data within a recording medium and/or storage via an optical record player.

Referring to FIG. 1, “Optical record player” 10 according to the present invention enables recording or playback of an optical disc according to various specifications. And, the optical record player 10 can be designed to record/play an optical disc (e.g., BD) of a specific specification. Moreover, the optical record player 10 can be made to play an optical disc only. In the following description of the present invention, by considering interactivity between a Blu-ray disc (BD) and a peripheral device, a BD-player reproducing a Blu-ray disc (BD) or a BD-recorder recording/playing a Blu-ray disc (BD) will be taken as an example. And, it is apparent that the “optical record player” 10 includes a “drive” loadable within a computer or the like.

The optical record player 10 according to the present invention is equipped with a function of recording/playing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of the Internet, as an easily accessible medium, specific data from the Internet can be downloaded via the optical record player 10.

The original data and the additional data will be explained in detail as follows. For instance, if a multiplexed AV stream for a specific title is recorded as original data within an optical disc and if an audio stream (e.g., English) different from the audio stream (e.g., Korean) of the original data is provided as an additional data from the Internet, a request for downloading the audio stream (e.g., English) as the additional data from the Internet to reproduce together with the AV stream of the original data, or a request for downloading the audio stream (e.g., English) as the additional data from the Internet to reproduce only, may be made by a user. To enable the requests, association between the original data and the additional data is regulated and a systematic method of managing/reproducing the data according to the user's request is provided.

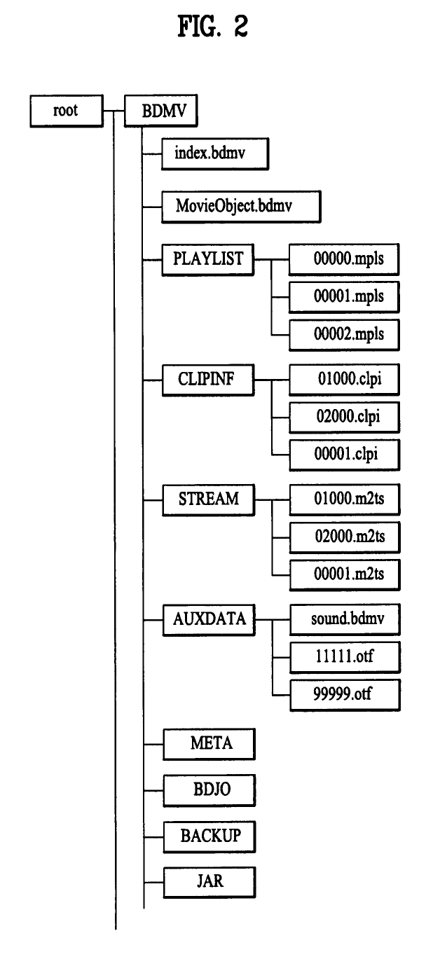

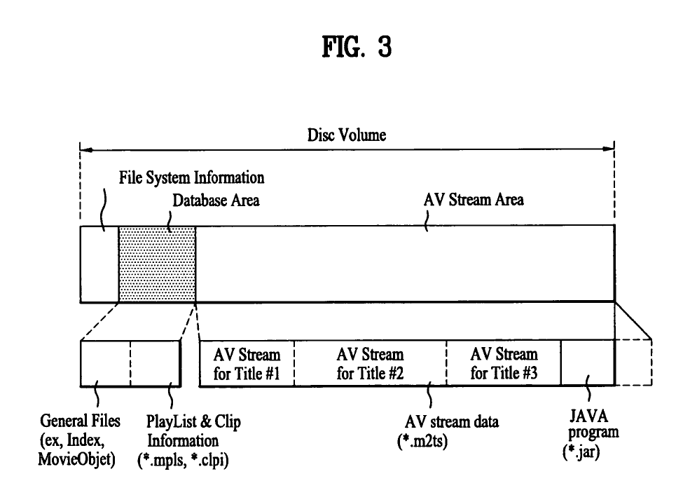

To realize the user's requests, a file structure between the original data and the additional data is provided. File and data structures usable for a Blu-ray disc (BD) are explained in detail with reference to FIG. 2 and FIG. 3 as follows.

FIG. 2 is a diagram of a file structure recorded within an optical disc as a recording medium according to an embodiment of the present invention. In particular, FIG. 2 shows a file structure for reproduction management of original data recorded within a disc.

Referring to FIG. 2, at least one BDMV directory exists below one root directory. An index file (“index”) and an object file (“MovieObject”) as general file (higher file) information to secure interactivity with a user exist within the BDMV directory. And, the BDMV directory includes a playlist directory (“PLAYLIST”), a clipinfo directory (“CLIPINF”), a stream directory (“STREAM”), an auxiliary directory (“AUXDATA”), a BD-J object directory (“BDJO”), a metadata directory (“META”), a backup directory (“BACKUP”) and a JAR director. The BACKUP directory has information of data actually recorded within a disc and information about a method of reproducing the recorded data. The other directories, and the files included in each of the directories, are explained in detail as follows.

The JAR directory includes JAVA program files.

The metadata directory (“META”) includes a metadata file as data about a data. Namely, in the metadata directory (“META”), a search file, a metadata file for Disc Library and the like exist as the metadata files to use for efficient search or management of data.

The BD-J object directory (“BDJO”) includes a BD-J Object file for reproducing a BD-J Title.

The auxiliary directory (“AUXDATA”) includes auxiliary files containing information for a disc playback. For instance, the AUXDATA directory may include a sound file (“Sound.bdmv”) providing click sound in case of an execution of interactive graphic and font files (“11111.otf” and “99999.otf”) providing font information in case of a disc playback.

In the stream directory (“STREAM”), AV stream files recorded within a disc in a specific format exist. Each of the streams is recorded as MPEG-2 transport packets in general, and “.m2ts” is used as an extension of a stream file (01000.m2ts, 02000.m2ts, etc.). In particular, a stream generated from multiplexing video, audio and graphic information together is named an AV stream and at least one or more AV stream files construct a title.

The clipinfo directory (“CLIPINF”) includes clip information files (01000.clpi, 02000.clpi, etc.) one-to-one corresponding to the stream files, respectively. In particular, a clip information file (“*.clpi”) includes attribute information and timing information of the corresponding stream file. In particular, the stream file (“*.m2ts”) and the clip information file (“*.clpi”) corresponding to the stream file (*.m2ts) are called collectively a “clip”. Namely, a “clip” is the data containing both of the stream file (“*.m2ts”) and the clip information file (“*.clpi”).

The playlist directory (“PLAYLIST”) includes playlist files (“*.mpls”). A playlist is a group of playing intervals for reproducing clips. And, a playing interval is called a PlayItem. Each of the playlist files (“*.mpls”) includes at least one PlayItem and SubPlayItem (SPI) designating a playing interval of reproducing a specific clip. The PlayItem and SubPlayItem (SPI) have information about a reproduction start time (IN-Time) and reproduction end time (OUT-Time) of a specific clip. So, the playlist can be called a set of PlayItems. And, metadata for managing a reproduction of a secondary video is included within the playlist file. Moreover, the metadata includes a reproduction time, reproduction position and size of the secondary video in association with the reproduction of the secondary video.

A reproduction process within PlayList file by at least one PlayItem is called “main path” and a reproduction process within PlayList file by each SubPlayItem is called “sub path”. The main path provides a master presentation of a playlist and the sub path provides auxiliary presentations associated with the master presentation. The main path should exist within the PlayList file and at least one sub path may exist according to a presence of SubPlayItem (SPI).

In the present invention, video data reproduced by the main path is also called primary video, and video data reproduced by the sub path is also called secondary video. A function of reproducing both of the primary and secondary videos by an optical record player may be “PiP (Picture in Picture).

The backup directory BACKUP stores a copy of the index file (“index”) recording information associated with a disc playback among data of the file structure, object files (MovieObject, BD-J Object), unit key file, all playlist files (“*.mpls”) within the playlist directory PLAYLIST, and all clip information files (“*.clpi”) within the clipinfo directory CLIPINF. Since the loss of the files may be fatal to the disc playback, the BACKUP directory stores these files for backup.

It is apparent that the file structure of the present invention is not limited to the above-explained names and positions. Namely, the directories and files should be understood not by their names and positions but by their meanings.

FIG. 3 is a diagram of a data record structure written on an optical disc as a recording medium according to an embodiment of the present invention, which shows how the aforesaid file structure associated information is recorded within a corresponding disc.

Referring to FIG. 3, in view from an inner circumference of a disc, there exist a file system information area as system information for managing an entire file, an area (“database area”) in which PlayList and clip information files are written to reproduce a recorded AV stream (*.m2ts), and an AV stream area in which a stream configured with audio/video/graphic or a JAR file is recorded.

And, an area for recording file information for reproducing contents within the stream area and the like is called a “Reproduction management area” and corresponds to the file system information area or the database area. In some cases, reproduction information of a stream can be recorded in a header of a stream within the stream area. In this case, the header corresponds to the management area as well. So, information associated with playback management can be recorded in the “reproduction management area”.

Yet, each area shown in FIG. 3 is exemplarily proposed. And, it is apparent that the present invention is not limited to the arrangement structure of the areas shown in FIG. 3.

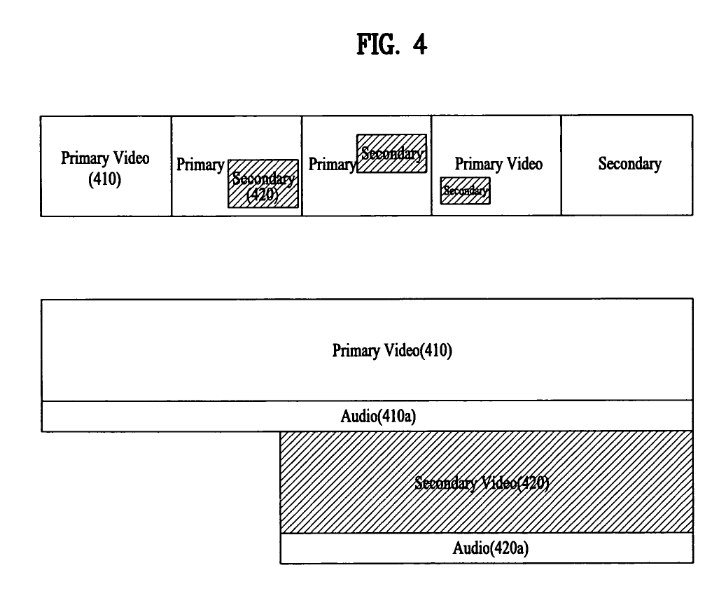

FIG. 4 is a diagram of a reproduction mode of secondary video according to embodiments of the present invention.

One embodiment of playing a secondary video on an image of a primary video that is being played is explained with reference to FIG. 4 as follows.

Referring to FIG. 4, another video data associated with a primary video 410 can be requested to be output to a same display unit 20 while the primary video is being played back. For instance, in the course of playing a movie or documentary, in case that a director's commentary for a shooting process is to be provided to a user, a video showing the commentary can be played back as a secondary video 420 together with the primary video 410. In doing so, the secondary video 420 may be played together with the playback of the primary video 410.

In some cases, a playback of the secondary video 420 may start in the middle of reproducing the primary video 410. And, it is also possible to display the secondary video 420 at a different position or size on a screen according to a playback process. Moreover, it is also possible to start or end a corresponding playback separately from a playback of the primary video 410. The primary video 410 can be played together with an associated audio 410a and the secondary video 420 can be played together with an associated audio 420a.

Information for a play timing point, play position, size of the secondary video and a stream constructing the secondary video is provided to play back the secondary video. And, information for defining an audio stream, presentation graphic or text subtitle stream (e.g., PiP PG textST stream) reproduced together with the secondary video and information for defining a permitted reproduction combination of the streams are provided as well. Moreover, an optical record player is provided with a memory unit (e.g., PSRs) storing a playback status of the secondary video and a playback environment.

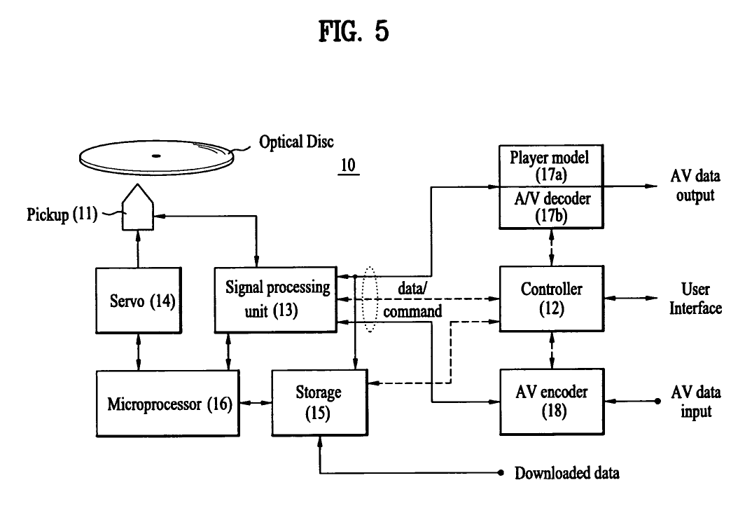

FIG. 5 is a block diagram of an overall configuration of an optical record player according to an embodiment of the present invention.

Referring to FIG. 5, an optical record player 10 according to one embodiment of the present invention includes a pickup 11 for reproducing original data and reproduction management information including playback management file information recorded in an optical disc, a servo 14 for controlling an action of the pickup 11, and a signal processor 13 for restoring a reproduction signal received from the pickup 11 to a specific signal value. The signal processor 13 also modulates a signal to be recorded into a signal recordable on the optical disc. A microprocessor 16 controls the overall operations of these elements.

The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user.

The optical recording/reproducing apparatus 10 further includes a playback system 17 for finally decoding data, and providing the decoded data to the user under the control of the controller 12. The playback system 17 includes an AV decoder 17b for decoding an AV signal. The AV decoder 17b may include a plurality of decoders. The playback system 17 also includes a player model 17a for analyzing an object command or application associated with playback of a particular title, for analyzing a user command input via the controller 12, and for determining a playback direction, based on the results of the analysis. In an embodiment, the player model 17a may be implemented as including the AV decoder 17a. In this case, the playback system 17 is the player model itself.

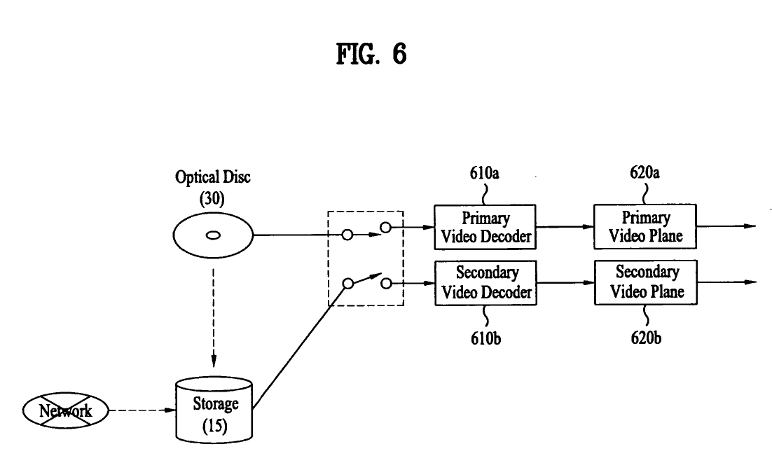

FIG. 6 is a schematic block diagram of a playback system according to an embodiment of the present invention.

Referring to FIG. 6, a decoder 17b according to one embodiment of the present invention includes a primary video decoder 610a decoding a primary video and a secondary video decoder 610b decoding a secondary video.

The decoded primary and secondary videos are output via primary and secondary video planes 620a and 620b to be provided to a user, respectively.

The controller 12 checks reproduction management data of the secondary video and controls the secondary video decoder 610b so that the secondary video can be decoded into a specific position and size at a specific timing point according to the metadata that manages a playback of the secondary video (this is described in more detail below). As stated, primary and/or secondary video stream data may be recorded in a recording medium 30 or may be downloaded to a storage 15 from an outside of the recording medium.

And, the optical record player 10 according to the present invention includes an AV encoder 18. To perform a function of recording a signal on an optical disc, the AV encoder 18 converts an input signal to a signal of a specific format, e.g., an MPEG2 transport stream according to a control of the controller 12 and then provides the converted signal to the signal processor 13. Like the AV decoder 17b, the AV encoder 18 can include a plurality of encoders. The controller 12 is able to control the primary and secondary video streams, primary and secondary audio streams, reproduction management data and the like, which are converted by the corresponding encoders to be provided to the signal processing unit 13, respectively, to be recorded on the optical disc.

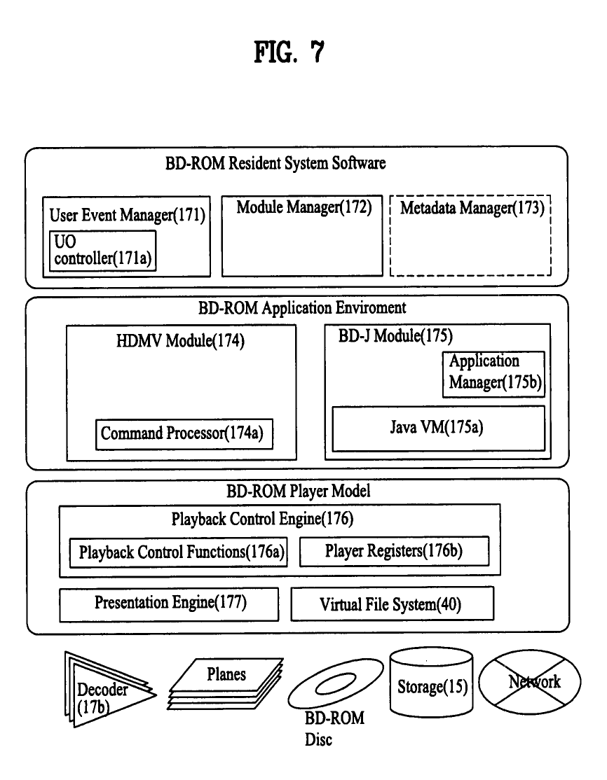

FIG. 7 shows a data reproducing apparatus utilizing a playback system according to an embodiment of the present invention, in which a secondary video is reproduced together with a primary video by the data reproducing apparatus.

Referring to FIG. 7, a “playback system” includes collection of reproduction processing means configured as programs (software) and/or hardware provided within an optical record player and/or stored on the recording medium and downloaded on the optical record player. The playback system plays a recording medium loaded in the optical record player, and simultaneously reproduces and manages the data that is associated with the recording medium such as that stored in a storage (e.g., data downloaded from outside).

In particular, a playback system 17 includes “User Event manager (171)”, “Module Manager (172)”, a “Metadata Manager (173)”, “HDMV Module (174)”, “BD-J Module (175)”, “Playback control engine (176)”, “Presentation engine (177)” and “Virtual File System (40)”, which are explained in detail as follows.

As separate reproduction processing management means for reproducing HDMV Title and BD-J Title, respectively, the “HDMV Module (174)” for HDMV Titles and the “BD-J Module (175)” for BD-J Titles are independently configured. Each of the “HDMV Module (174)” and the “BD-J Module (175)” has a control function for receiving a command or program within the aforesaid object (Movie Object or BD-J Object), and processing the command or program. The “Metadata Manager (173)” is able to perform a title selection and to provide a recording medium and title metadata to a user at any time under a user's control. The “HDMV Module (174)” and “BD-J Module (175)” enable a portability of a command or application by separating the command or application from a hardware configuration of the playback system. As a means for receiving to process the command, application or the like, a “Command processor (174a) is provided within the “HDMV Module (174), and a “Java VM (175a)” and an “Application manager (175b)” are provided within the “BD-J Module (175).

The “Java VM (175)” is “Virtual Machine” (VM) executing an application. The “Application manager (175b)” includes an application management function of managing a lifecycle of an application.

Moreover, the “Module Manager (172)” is provided to deliver a user command to the “HDMV Module (174)” or the “BD-J Module (175)” and to control an operation of the “HDMV Module (174)” or the “BD-J Module (175)”.

A “Playback control Engine (176)”, which is also provided, interprets PlayList file information recorded within a disc according to a reproduction command of the “HDMV Module (174)” or the “BD-J Module (175)” and performs a corresponding reproduction function. Moreover, a “Presentation Engine (177)” for decoding a specific stream reproduced and managed by the “Playback Control Engine (176)”, and for displaying the decoded stream on a screen is provided. Specifically, the “Playback Control Engine (176)” includes “Playback Control functions (176a)” actually managing reproductions and “Player Registers (176b)” storing player status registers (PSRs) and general purpose registers (GPRs). In some cases, “Playback Control functions (176a)” may mean “Playback Control Engine (176)”.

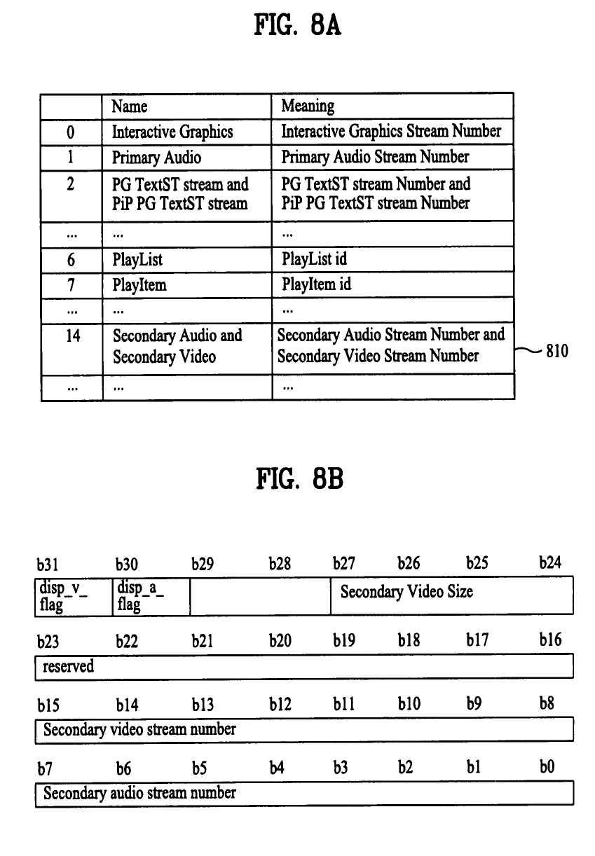

In an embodiment of the present invention, the “Player registers (176b)” becomes a memory unit indicating a playback status of the secondary video. The memory unit will be explained in detail with reference to FIG. 8 later.

The HDMV title and BD-J title receive user commands in separate types, respectively, and independently perform the user commands. A means for receiving and delivering a user command to either the “HDMV Module (174)” or “BD-J Module (175)” is provided by the “User Event Manager (171)”. So, if a received command is a user command by “User Operation (UO)”, the “User Event Manager (171)” transfers it to the “Module Manager (172)” or “UO controller (171a)” to perform the user command. If a received command is a user command by “Key Event”, the “User Event Manager (171)” transfers it to the “Java VM (175a)” within the “BD-J Module (175)” to perform the user command.

And, the playback system 17 according to the present invention may include the “Metadata Manager (173)” that provides disc library and enhanced search metadata applications to a user.

In the above-explained playback system of the present invention, the “Module Manager (172)”, the “HDMV Module (174)”, the “BD-J Module (175)” and the “Playback Control Engine (176)” are enabled in software. Software processing tends to be more advantageous than a hardware configuration in design. Yet, the “Presentation Engine (177)”, the decoders and the planes are normally designed by hardware. In particular, the elements (e.g., reference numbers 172, 174, 175, 176) performed by software can be configured with a portion of the controller 12. Hence, the configuration of the present invention should be understood by its meaning but is not limited to a hardware configuration or a software configuration.

FIG. 8A is an exemplary diagram of a status memory unit provided in a reproducing apparatus according to an embodiment of the present invention and FIG. 8B is an exemplary diagram of a player status register (PSR) 14 as a part of the status memory unit shown in FIG. 8A.

The optical record player 10 includes “Player Registers (176b)” as sort of memory units storing information for record playback status and environment of the player. The “Player Registers (176b)” can be divided into “General purpose Registers (GPRs)” and “Player Status Registers (PSRs)”.

The “Player Status Registers (PSRs)” can be divided into “Playback Status Registers” storing playback status parameters (e.g., ‘interactive graphics stream number’ and ‘primary audio number’) and “Player Setting Registers” storing optical record player configuration parameters.

In the embodiment of the present invention, “Player Status Registers (PSRs)” storing a playback status of a secondary video is needed to play back the secondary video as well as a primary video.

In particular, the present invention relates to PSR14 storing status information of a secondary video (e.g., a number or size of a currently reproduced video stream) or information on enabling or disabling a playback possibility of the secondary video.

In one embodiment, PSR14 810 as one of “Player Status Registers (PSRs)” can store a secondary video stream number. And, the PSR (hereinafter named PSR14) can store a secondary audio stream number associated with the secondary video.

As shown in FIG. 8B, the PSR 14 includes a “Secondary video stream number” field, a “Secondary audio stream number” field, a “Secondary Video Size” field, a “disp_v_flag” and a “disp_a_flag”.

A secondary video stream number is stored in the “Secondary video stream number” field. In this case, the secondary video stream number is used in specifying which secondary video stream to present from secondary video stream entries within an STN table of a current playitem.

The secondary video stream number is a value for a secondary video stream entry and is obtained by adding ‘1’ to a secondary video stream identifier defined in the STN table. This is because the secondary video stream identifier is initialized to ‘0’.

The secondary video stream number may be set in one embodiment from 1 to 32. If a value stored in the “secondary video stream number” field is ‘0xFE’, it means that a current status is “Valid’, which means that a secondary video stream is not selected although a secondary video can be played back. If a value stored in the “secondary video stream number” field is ‘0xFF’, it means that a secondary video stream is not selected or does not exist.

A secondary audio stream number is stored in the “Secondary audio stream number” field. In this case, the secondary audio stream number is used in specifying the secondary audio stream to be presented from secondary audio stream entries within an STN table of a current playitem.

The secondary audio stream number is a value for a secondary audio stream entry and is obtained by adding ‘1’ to a secondary audio stream identifier defined in the STN table. This is because the secondary audio stream identifier is initialized to ‘0’.

The secondary audio stream number may be set, in one embodiment, to 1 to 32. If a value stored in the “secondary audio stream number” field is ‘0xFF’, it means that a secondary audio stream is not selected or does not exist.

A secondary video size may be stored in the “Secondary Video Size” field.

For instance, if a value stored in the “Secondary Video Size” field is ‘0x0’, a playback size of the secondary video is adjusted according to secondary video size information included in management data reproduced from the recording medium. If a value stored in the “Secondary Video Size” field is ‘0xF’, a size is adjusted into a full-screen size regardless of secondary video size information included in reproduced management data. In this case, the full-screen size means that the playback size of the secondary video is adjusted into the same size as that of the primary video. The secondary video size information may be included in the management data on the recording medium, and may be more particularly included in metadata for managing a playback of a secondary video.

The “disp_v_flag” stored in the PSR14 810 is a flag indicating whether to ‘enable’ or ‘disable’ a screen display of the secondary video.

For instance, if the flag “disp_v_flag” is set to ‘disable’ (0_{b}), the secondary video is not played back although the secondary video is being decoded by the decoder 610b. Hence, a user is unable to view the secondary video. For example, even if the secondary video stream presentation is disabled by changing the disp_v_flag during presentation of the secondary video stream, the secondary video decoder 610a may continue to decode the secondary video stream, but the secondary video is not displayed.

On the other hand, if the flag “disp_v_flag” is set to ‘enable’ (1_{b}), the secondary video is decoded by the decoder 610b and a user is able to view the secondary video via the secondary video plane 620b.

A value of the flag “disp_v_flag” can be changed by a command generated from a user operation (UO), playback system or application programming interface (hereinafter abbreviated API). Hence, a playback of the secondary video can be controlled despite the execution of the PiP function.

The “disp_a_flag” stored in the PSR14 810 is a flag indicating whether to ‘enable’ or ‘disable’ a playback of the secondary audio.

For instance, if the flag “disp_a_flag” is set to ‘disable’ (0_{b}), the secondary audio is not played back although the secondary audio may continue to be decoded by the decoder 610b. Hence, a user is unable to listen to the secondary audio. On the other hand, if the flag “disp_a_flag” is set to ‘enable’ (1_{b}), the secondary audio is decoded by the decoder 610b, and a user is able to listen to the secondary audio.

A value of the flag “disp_a_flag” can be changed by a command (specifically, navigation command in playback system) generated from a user operation (UO), playback system or application programming interface (hereinafter abbreviated API). Hence, a playback of the secondary audio associated with the secondary video can be controlled despite the execution of the PiP function.

In the aforesaid PSR14, play status information associated with a secondary video to be played according to reproduction management data is stored. The controller 12 checks the secondary video to be played according to the reproduction management data and controls playback status information associated with the checked secondary video stored in the PSR14. And, the controller 12 may control the secondary video to be played back by checking the playback status information stored in the PSR14.

It may happen that a secondary video is or is not displayed regardless of metadata that manages a playback of the secondary video included in the playback status management data. For instance, if the playback status information defines that the secondary video is not displayable, the secondary video is not displayed regardless of other information for the secondary video. If the playback status information defines that a reproduction size of the secondary video is equal to that of a primary video, the secondary video is played back at the same size as the primary video regardless of size information of the secondary video included in the playback status information.

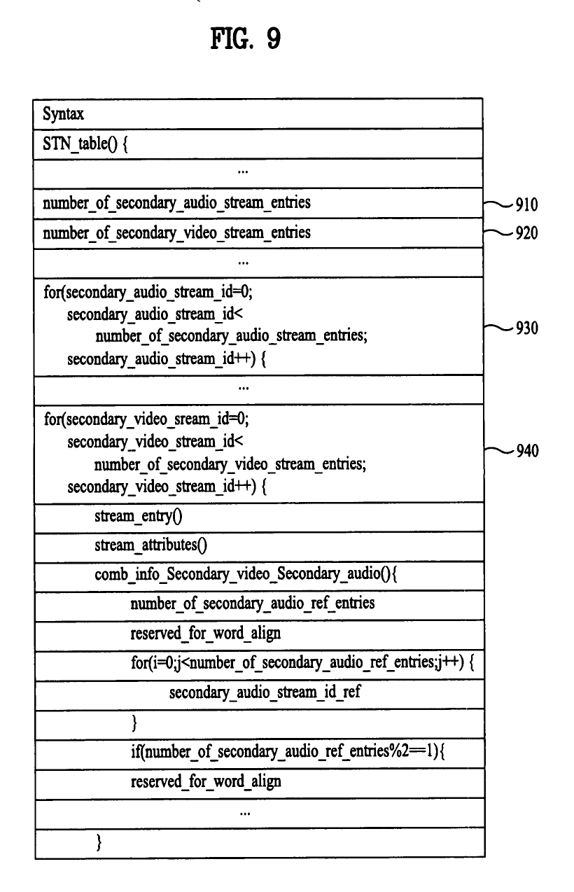

FIG. 9 is an exemplary diagram of the syntax of a table including information for a secondary video stream according to an embodiment of the present invention.

The table (hereinafter called the STN table) defines a list of basic streams that can be selected by an optical record player 10 during a playback of sub-paths associated with a current playitem. And, the STN table is provided in each playitem included in a playlist.

The optical record player 10 according to the present invention possesses a function of processing a secondary video, a secondary audio and a text subtitle. So, the STN table according to the present invention stores entries associated with a secondary video, a secondary audio, a presentation graphic and a text subtitle.

Referring to FIG. 9, a “number_of_secondary_audio_stream_entries” field 910, a “number_of_secondary_video_stream_entries” field 920 and fields for defining entries of respective streams are included in an STN table.

The “number_of_secondary_audio_stream_entries” field 910 indicates a number of secondary audio stream entries recorded on the recording medium.

The “number_of_secondary_video_stream_entries” field 920 indicates a number of recorded “secondary video stream entries” recorded on the recording medium.

In association with the secondary audio streams, initially a secondary audio stream identifier (‘secondary_audio_stream_id’) is initialized to ‘0’ (930). The secondary audio stream identifiers are generated by adding 1 to the previous secondary audio stream identifier as long as the ‘number_of_secondary_audio_stream_entries’ has not been reached (930).

Similarly in association with secondary video streams, initially a secondary video stream identifier (‘secondary_video_stream_id’) is initialized to ‘0’ (940). The secondary video stream identifiers are generated by adding 1 to the previous secondary video stream identifier as long as the ‘number_of_secondary_video_stream_entries’ has not been reached (940).

A “stream entry( )” field in the STN table indicates information for a stream entry. For instance, it indicates information for length and type of a stream. And, depending on the indicated type, the stream entry identifies the specific stream of a main clip or a sub clip, and may also identify a subpath for the stream.

In particular, a database for identifying an elementary stream referred to by a stream number for a stream entry is stored in a “type” field included in the “stream entry( )” field.

And, the “stream entry( )” field includes a subclip entry id defined by a subplayitem of a subpath referred to by an identifier (“subpath entry id”) identifying a subpath entry associated with a playback of a secondary video.

A “stream attribute( )” field in the STN table indicates information for a stream attribute. For instance, this field indicates information for a frame rate of a video stream associated with a video format.

An optical record player 10 according to an embodiment of the present invention is able to reproduce a suitable video stream according to information defined by the STN table using information included in metadata for PiP playback management.

For instance, a stream entry field (“stream entry( )”) associated with a playback of a secondary video can be known from “PlayItem_id” and “secondary_video_stream_id” included in metadata for PiP playback management. Since information for identifying an associated subpath and subclip entry is stored in the stream entry field (“stream entry( )”), streams suitable for the secondary video playback can be reproduced. Since the secondary video is played back according to the subpath, once the “PlayItem_id” and “secondary_video_stream_id” are determined, a playback time of the secondary video and a playback sequence of streams configuring the secondary video are determined.

Furthermore, the STN table includes “comb_info_Secondary_video_Secondary audio” field, as shown in FIG. 9. This field includes combination information for defining allowed combinations of secondary video and secondary audio. In case that the secondary video is selected in PSR14, the secondary audio is selected based on this combination information.

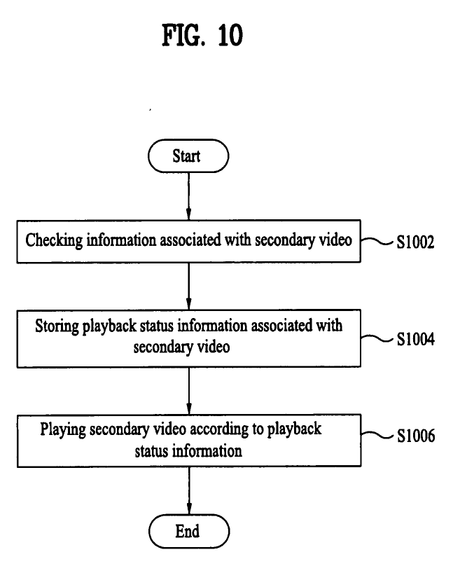

FIG. 10 is a flowchart of a method of reproducing data according to an embodiment of the present invention.

Referring to FIG. 10, an optical record player 10 according to the present invention reads and checks information associated with a secondary video stream included in data recorded in a recording medium (S1002). Herein, the data includes a primary video stream, a secondary video stream and reproduction management data for managing reproductions of theses streams.

For instance, in case of a recording medium input or power-on, the optical record player 10 reads a STN-table within the recording medium and then checks information associated with the secondary video stream. In this case, the information associated with the secondary video stream includes a number of secondary video stream entries, a secondary video stream entry id and the like.

Subsequently, the optical record player 10 stores the playback status information associated with the secondary video stream in a memory unit (S1004). The playback status information includes a secondary video stream number, information for a secondary video playback size, enablement of a secondary video screen display and the like. The secondary video stream number can indicate one of the secondary video stream entries of the STN table included in a playlist and corresponds to the secondary video stream entry identifier. The memory unit may include one or more of the player status registers (PSRs) included in the optical record player 10.

For instance, the optical record player 10 selects a secondary video stream having a lowest number from among secondary video stream numbers corresponding to the secondary video stream entry identifiers read in the step S1002 and then stores the corresponding secondary video stream number in the PSR14.

Subsequently, (S1006) the optical record player 10 plays the secondary video stream based on the playback status information associated with the secondary video stream stored in the memory unit (e.g., PSR 14).

Herein, the selected secondary video stream shall be a stream reproducible in the player.

In case that there exists a secondary video stream previously designated by a user operation (UO), playback system or application programming interface (hereinafter abbreviated API) or the like, a number of the corresponding secondary video stream shall be recorded in the memory unit (e.g., PSR 14). And, a priority of a playback sequence can be designated according to a type of a secondary video stream as well. Furthermore, where multiple secondary video streams are available, it will be understood that selection may be made by a user operation (UO), playback system or application programming interface (hereinafter abbreviated API) or the like—including commands reproduced from the recording medium.

Moreover, a secondary video stream is presented according to information for a secondary video playback size included in the playback status information. For instance, in reproducing the secondary video stream, if information for the secondary video playback size included in the playback status information defines that the secondary video shall be played at a size defined by a playlist, it is able to play back the secondary video at a secondary video size stored in the playlist.

Accordingly, the present invention provides the advantage such as a secondary video can be played together with a primary video, a content provider may provide various contents, and a user may simultaneously view the provided various contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of managing reproduction of secondary video stream downloaded from an external source comprising:
receiving the secondary video stream from an external source;
selecting which one of a secondary video stream received from an external source or a secondary video stream a recording medium;
determining the selected secondary video stream to reproduce with a primary video stream based on management information stored in a memory, the secondary video stream representing the picture-in-picture presentation path with respect to a primary presentation path represented by a primary video stream, the management information including identifying information identifying the secondary video stream to reproduce, and the management information including display information indicating whether to display the secondary video stream; and
reproducing the determined secondary video stream based on the management information.

2. The method of claim 1, wherein a state of the display information is set based on an instruction.

3. The method of claim 2, wherein the instruction is received from a user.

4. The method of claim 2, wherein the instruction is received from an application program interface.

5. The method of claim 1, wherein the reproducing step comprises:
decoding the secondary video stream even if the display information indicates not to display the secondary video stream.

6. The method of claim 1, further comprising:
reading a management table from navigation information recorded on a recording medium, the navigation information including secondary video stream entries; and
storing the identifying information for a selected one of the secondary video stream entries in the memory as part of the management information.

7. The method of claim 6, wherein the navigation information is a playitem, and the playitem provides a playback interval of the primary video stream.

8. The method of claim 6, wherein
the management table further includes combination information, the combination information indicating the secondary audio streams that are combinable with the secondary video stream; and the method further including,
storing, as the identifying information, a secondary audio stream number identifying a selected one of the secondary audio streams indicated by the combination information.

9. The method of claim 1, further comprising:
determining a secondary audio stream to reproduce with the secondary video stream based on the management information stored in the memory; and
reproducing the determined secondary audio stream based on the management information.

10. The method of claim 9, wherein the management information includes a flag indicating whether to play the secondary audio stream.

11. The method of claim 10, wherein a state of the flag is set based on an instruction.

12. A reproduction apparatus of reproducing secondary video stream downloaded from an external source, comprising:
a storage configured to store management information, the management information indicating a secondary video stream to reproduce and indicating whether the secondary video stream is to be displayed;
the storage configured to store data including secondary video stream from an external source; and
a controller configured to control reproduction of the secondary video stream based on the management information, the secondary video stream representing the picture-in-picture presentation path with respect to a primary presentation path represented by a primary video stream.

13. The apparatus of claim 12, wherein the memory unit includes at least one status register.

14. The apparatus of claim 12, wherein the management information includes a flag indicating whether to display the secondary video stream.

15. The apparatus of claim 13, wherein the controller sets a state of the flag based on a received instruction.

16. The apparatus of claim 15, wherein the instruction is received from a user.

17. The apparatus of claim 16, wherein the instruction is received from an application program interface.

18. The apparatus of claim 12, further comprising:
a decoder configured to decode the secondary video stream; and wherein
the controller is configured to control the decoder to decode the secondary video stream even if the management data indicates not to display the secondary video stream.

19. The apparatus of claim 12, further comprising:
a driver configured to drive a reproducing device to reproduce data; and wherein
the controller is configured to control the driver to reproduce a management table, the management table indicating a number of secondary video stream entries, and the controller storing a secondary video stream number identifying a selected one of the number of secondary video stream entries in the memory unit as part of the management information.

20. The apparatus of claim 19, wherein the management table is included in at least one playitem of a playlist recorded in the recording medium, the playitem indicating a playing interval of the primary video stream, and the playlist indicating which playitems to reproduce.

21. The apparatus of claim 12, wherein the management information indicates a secondary audio stream to reproduce and indicates whether the secondary audio stream is to be played.

22. The apparatus of claim 21, wherein the management information includes a flag indicating whether to play the secondary audio stream.

23. The apparatus of claim 22, wherein the controller sets a state of the flag based on an instruction.
